(19) United States
(12) Patent Application Publication
(10) Pub. No.: US 2025/0213012 A1
(43) Pub. Date: Jul. 3, 2025

(54) BUCKLE BELT AND MANUFACTURING METHOD FOR BUCKLE BELT

(71) Applicant: YKK Corporation, Tokyo (JP)

(72) Inventors: Atsushi Nakaya, Toyama-ken (JP); Shinsuke Saiga, Shanghai (CN); Jun Hashizume, Toyama-ken (JP); Zhiyu Ren, Toyama-ken (JP); Tsuyoshi Minato, Toyama-ken (JP); Shinichi Imai, Toyama-ken (JP); Yuta Inoue, Tokyo (JP); Kyohei kawasaki, Toyama-ken (JP); Deshmukh Sarang, Toyama-ken (JP)

(21) Appl. No.: 18/848,806

(22) PCT Filed: Mar. 28, 2022
(86) PCT No.: PCT/CN2022/083401

§ 371 Date: Sep. 19, 2024

(51) Int. Cl. A44B 18/00

(52) U.S. Cl. CPC A44B 18/0003

(57) ABSTRACT

A surface fastener to be integrated with a surface of a cushion body includes: a base made of resin and having a first surface and a second surface that are in a front-back relationship; multiple engagement elements provided in an element region of the first surface of the base; and a porous member provided on the second surface of the base and having flexibility. The base includes a body including the element region, and a flange extending from the body and having a shape that is bent toward the second surface with respect to the body. The porous member includes a compressed portion compressed between the body and the flange.

### TECHNICAL FIELD

The invention relates to a surface fastener and a method of manufacturing a surface fastener.

### BACKGROUND ART

Seats, chairs, etc., of vehicles each generally have a cover material attached to a surface of a cushion body. As an exemplary method of attaching the cover material to the surface, a method using a surface fastener is known. In such a method, the surface fastener is set inside a molding tool, then a raw material of the cushion body is injected into the molding tool to be foamed and solidified, and the surface fastener is thereby integrated with the surface of the cushion. Thereafter, the cover material is engaged with the surface fastener integrated with the cushion body, to be thereby attached to the surface of the cushion body.

Patent Literature 1 discloses a surface fastener (a fastening tape) to be used in the above-described attachment method. The surface fastener includes a base having a band shape and multiple engagement elements protruding from the base. The multiple engagement elements are provided at a body of the base, and the base includes a flange that is bent toward a side of the body opposite to a side on which the multiple engagement elements are provided. Since the flange is disposed in a state of being placed deeply in the cushion body, adhesion property of the surface fastener to the cushion body can be improved.

### CITATION LIST

### Patent Literature(s)

Patent Literature 1: JP 2018-99516 A

### SUMMARY OF THE INVENTION

However, in a conventional art disclosed in Patent Literature 1, when a load is applied to the surface fastener, for example, during distribution of the surface fastener prior to integration with a cushion body, the flange is easily bent back by the load. For example, when multiple surface fasteners are stacked on each other and are packed in the stacked state, the flange of the surface fastener disposed below may be bent back by a load applied from the surface fastener disposed above to the surface fastener disposed below.

It is an object of the invention to provide a surface fastener and a method of manufacturing a surface fastener capable of improving adhesion property of the surface fastener to a cushion body while maintaining a bent shape of a flange.

According to an aspect of the invention, a surface fastener to be integrated with a surface of a cushion body includes: a base made of a resin, the base having a first surface and a second surface that are in a front-back relationship; a plurality of engagement elements provided in an element region of the first surface of the base; and a porous member provided on the second surface of the base and having flexibility, in which the base includes: a body including the element region; and a flange extending from the body and having a shape that is bent toward the second surface with respect to the body, and the porous member includes a compressed portion compressed between the body and the flange.

With such a configuration, it is possible that the compressed portion of the porous member supports a load applied to the surface fastener, and therefore a load in a direction of widening the bent shape is hardly applied to the flange. Accordingly, the bent shape of the flange can be maintained.

Further, a raw material of the cushion material is permeable into the porous member, and therefore the flange is disposed in a state of being placed deeply in the cushion body, though the porous member exists between the flange and the body. This makes it possible to achieve installation of the surface fastener in a cushion body without impairing adhesion property of the surface fastener that is an original object of the flange. In addition, the permeation of the raw material of the cushion material into the porous member increases a contact area between the surface fastener and the cushion material, which makes it possible to improve the adhesion property of the surface fastener.

Thus, according to the aspect of the invention, the surface fastener is provided that is capable of improving the adhesion property of the surface fastener to the cushion body while maintaining the bent shape of the flange.

In the aspect of the invention, it is preferable that the porous member is provided on the second surface of the base, to cover the body and the flange.

With such a configuration, the porous member has a shape that is bent between the body and the flange, and it is possible to suitably provide the compressed portion.

In the aspect of the invention, where a direction from the first surface toward the second surface in the body is defined as a predetermined direction, the porous member preferably further includes a protrusion protruding farther in the predetermined direction than the flange.

With such a configuration, when the cushion body is formed, it is possible to dispose the protrusion deeply inside the cushion body and to further improve the adhesion property of the surface fastener.

In the aspect of the invention, it is preferable that the porous member further includes a non-compressed portion disposed at the body, and a recess is provided between the non-compressed portion and the protrusion.

With such a configuration, when the cushion body is formed, the raw material of the cushion body flows into the recess and solidifies, which makes it possible for the porous member to hold a part of the cushion body. Accordingly, it is possible to further improve the adhesion property of the surface fastener.

In the aspect of the invention, the porous member is preferably made of foam.

With this arrangement, it is possible to easily compress the porous member, and to easily form the compressed portion of the porous member by performing a bending process on the base.

In the aspect of the invention, the compressed portion may be cured by welding or by an adhesive.

With this arrangement, it is possible to suppress an elastic force of the compressed portion, and to more suitably maintain the bent shape of the flange.

In the aspect of the invention, the base may include, as the flange, a first flange and a second flange, the first flange extending from one side in a width direction of the body, the second flange extending from another side in the width direction of the body, and the porous member may include the compressed portion between the body and the first flange and the compressed portion between the body and the second flange.

With such a configuration, since the compressed portion is formed on both sides in the width direction of the body, it is possible for the compressed portion to share and support a load applied to the surface fastener. Accordingly, it is possible to suitably maintain the respective bent shapes of the first flange and the second flange.

According to another aspect of the invention, a method of manufacturing a surface fastener to be integrated with a surface of a cushion body is provided, the method including: preparing a fastener body, the fastener body including a base made of a resin and multiple engagement elements, the base having a first surface and a second surface that are in a front-back relationship, the multiple engagement elements being provided in an element region of the first surface of the base;

adhering a porous member to the second surface of the base, the porous member having flexibility; and bending an end edge portion together with the porous member toward the second surface of the base, the end edge portion being a region outside the element region of the base.

With such a method, it is possible to suitably manufacture the surface fastener in the above aspect of the invention.

In the other aspect of the invention, in the bending, an external force is preferably applied to the end edge portion until a bending angle of the end edge portion with respect to the body becomes less than or equal to 90 degrees.

With such a method, it is possible to suitably maintain the bent shape of the end edge portion (i.e., the flange) while raising the end edge portion from the body, by utilizing restoring of the end edge portion to its original state to some extent with use of an elastic force of the end edge portion and/or a repulsive force of the porous member.

### EFFECTS OF THE INVENTION

According to the above aspects of the invention, it is possible to provide a surface fastener and a method of manufacturing a surface fastener capable of improving the adhesion property of the surface fastener to a cushion body while maintaining a bent shape of a flange.

### BRIEF DESCRIPTION OF DRAWINGS

FIG. 1 is a cross-sectional diagram of a surface fastener according to one exemplary embodiment of the invention.

FIG. 2 is a plan view of the surface fastener according to the exemplary embodiment.

FIG. 3 is a diagram for describing a method of manufacturing the surface fastener according to the exemplary embodiment, and is a cross-sectional diagram illustrating a state prior to a bending step.

FIG. 4 is a diagram for describing the method of manufacturing the surface fastener according to the exemplary embodiment, and is a plan view of the state prior to the bending step.

FIG. 5 is a diagram for describing the method of manufacturing the surface fastener according to the exemplary embodiment, and is a cross-sectional diagram illustrating a state after the bending step.

FIG. 6 is a cross-sectional diagram illustrating another example of the surface fastener according to the exemplary embodiment.

FIG. 7 is a diagram illustrating an example of installing the surface fastener according to the exemplary embodiment in a molding tool of a cushion body.

FIG. 8 is a diagram illustrating a state where surface fasteners of the exemplary embodiment are stacked on each other.

FIG. 9 is a partial perspective view of a surface fastener according to a modification of the exemplary embodiment.

FIG. 10 is a partial perspective view of a surface fastener according to another modification of the exemplary embodiment.

FIG. 11 is a diagram illustrating a state where surface fasteners of a comparative example are stacked on each other.

### EXPLANATION OF CODES

1: surface fastener, 10, 10P: fastener body, 20, 20P: base, 21: first surface, 22: second surface, 23: body, 231A: one end portion, 231B: another end portion, 24A: first flange (flange), 24B: second flange (flange), 25A, 25B: end edge portions, 26: V-shape groove, 31: engagement element, 32: wall, 33: magnetic element, 40, 40P: porous member, 41A, 41B: compressed portions, 42A, 42B: protrusions, 43: non-compressed portion, 44: adhesion surface, 45: recess, 47: adhesion layer, 51: molding tool, 52: base portion, 53: magnet, 60: cushion body, R: element region

### DETAILED DESCRIPTION

An exemplary embodiment of the invention will be described below with reference to the drawings.

A surface fastener 1 of the exemplary embodiment is to be integrated with a surface of a cushion body that is a component of a seat, a chair or the like of a vehicle, and is used to attach a cover material to the cushion body.

### Configuration of Surface Fastener 1

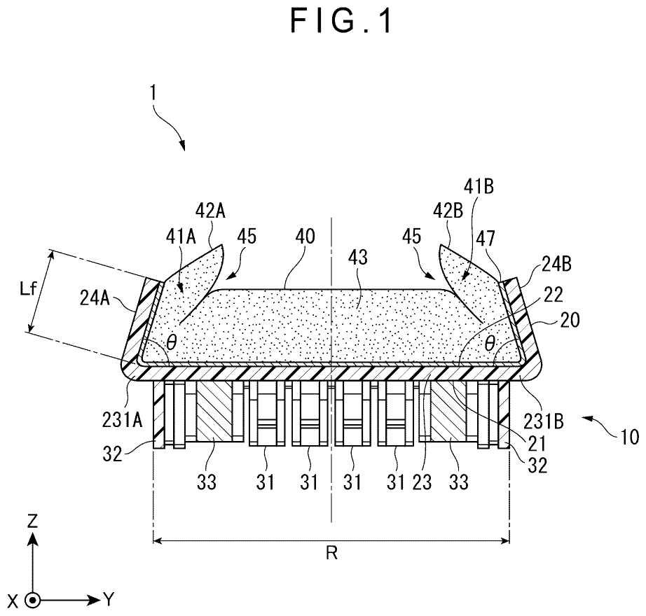

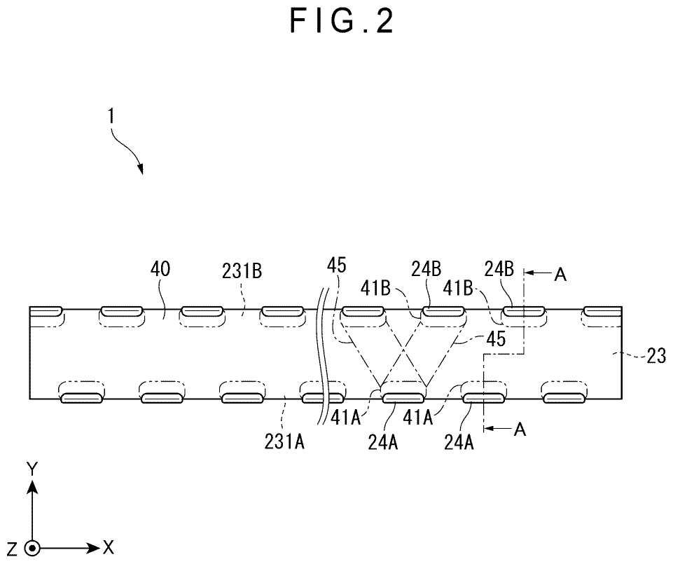

A configuration of the surface fastener 1 according to the exemplary embodiment will be described with reference to FIGS. 1 and 2. Note that FIG. 1 is a cross-sectional diagram taken along a line A-A and viewed in a direction indicated by arrows in FIG. 2.

The surface fastener 1 includes a base 20 made of a resin, multiple engagement elements 31, and a porous member 40. The base 20 has a first surface 21 and a second surface 22 that are in a front-back relationship. The multiple engagement elements 31 are provided in an element region R of the first surface 21 of the base 20. The porous member 40 is provided on the second surface 22 of the base 20 and has flexibility. Note that the base 20 and the multiple engagement elements 31 configure a fastener body 10 that is integrally made of a synthetic resin or the like.

The base 20 includes a body 23 including the element region R, and multiple flanges 24A and 24B each extending from the body 23 and each having a shape that is bent toward the second surface 22 with respect to the body 23.

Note that the base 20 has a band shape as a whole in the exemplary embodiment. In the following description, a length direction of the base 20 is defined as an X direction, and a width direction of the base 20 is defined as a Y direction. A direction from the first surface 21 toward the second surface 22 (corresponding to a predetermined direction in the invention) in the body 23 of the base 20 is defined as a Z direction. The X, Y, and Z directions are orthogonal to each other.

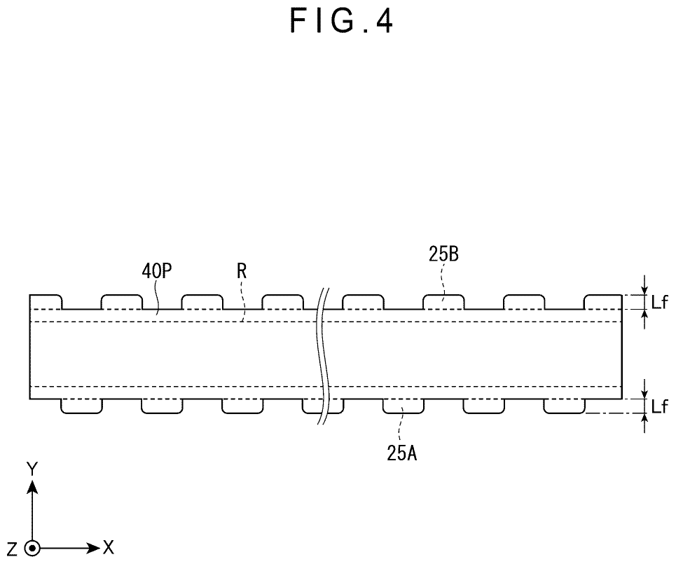

The body 23 includes the element region R that is a region in which components including the multiple engagement elements 31 are provided. The element region R has a constant width in the Y direction and is continuous in the X direction (see FIG. 4). Further, not only the multiple engagement elements 31 but also multiple walls 32 and multiple magnetic elements 33 may be provided in the element region R.

Respective specific configurations of the engagement elements 31, the walls 32, and the magnetic elements 33 may be similar to those of the conventional art. For example, the engagement elements 31 each include a projection projecting from the first surface 21 of the base 20 and a hook provided at an end of the projection, and the multiple engagement elements 31 are provided at predetermined pitches in each of the X direction and the Y direction in the element region R. The walls 32 are provided along the X direction on each of both sides in the Y direction of the multiple engagement elements 31. The magnetic elements 33 are each made of a synthetic resin containing a magnetic material, and are provided along the X direction in each of regions between the engagement elements 31 and the walls 32.

The flanges 24A and 24B correspond to flanges in the invention, and hereinafter are occasionally referred to as a first flange 24A and a second flange 24B, respectively. The first flange 24A and the second flange 24B have configurations similar to each other except for their locations with respect to the body 23.

Specifically, the first flange 24A extends from one end portion 231A in the Y direction of the body 23. The base 20 of the exemplary embodiment includes multiple first flanges 24A arranged at predetermined intervals in the X direction.

The second flange 24B extends from another end portion 231B in the Y direction of the body 23. The base 20 of the exemplary embodiment includes multiple second flanges 24B arranged at predetermined intervals in the X direction. Note that it is preferable that respective locations of the multiple first flanges 24A and respective locations of the multiple second flanges 24B are deviated from each other in the X direction.

The flanges 24A and 24B each have a shape that is bent toward the second surface 22 of the base 20 with respect to the body 23. A bending angle θ of each of the flanges 24A and 24B is not particularly limited, and is preferably 90 degrees±10 degrees, and more preferably less than 90 degrees. Note that the bending angle θ in the exemplary embodiment is an angle between the second surface 22 of the body 23 and the second surface 22 of each of the flanges 24A and 24B, as illustrated in FIG. 1.

The porous member 40 may be made of any porous material having flexibility, and examples of the porous material include a nonwoven fabric, foam, or a meshed material. For example, the porous member 40 of the exemplary embodiment is assumed to be made of urethane in a form of foam.

The porous member 40 is adhered to the second surface 22 of the base 20 by any adhesive material. That is, the porous member 40 is fixed to the second surface 22 of the base 20 with any adhesion layer 47 interposed therebetween. The porous member 40 is provided on the second surface 22 of the base 20, to cover the body 23 and the flanges 24A and 24B. The porous member 40 has a shape that is bent together with the flanges 24A and 24B toward the second surface 22 of the base 20 with respect to the body 23.

Specifically, the porous member 40 includes a compressed portion 41A that is compressed between the body 23 and the first flange 24A, and a compressed portion 41B that is compressed between the body 23 and the second flange 24B. When the porous member 40 is bent together with the flanges 24A and 24B toward the second surface 22 of the base 20 with respect to the body 23, the porous member 40 is compressed to thereby form the compressed portions 41A and 41B. The compressed portions 41A and 41B each have a high density and a high strength as compared with a non-compressed portion 43 and protrusions 42A and 42B, which will be described later, in the porous member 40. Note that, in FIG. 2, respective areas of the compressed portions 41A and 41B in the porous member 40 are each indicated by a two-dot chain line. The compressed portions 41A and 41B may each be cured by welding or by an adhesive.

The porous member 40 includes the non-compressed portion 43 that is disposed on the body 23 between the compressed portions 41A and 41B in the width direction (the Y direction) of the base 20 and is not compressed by the flanges 24A and 24B.

The porous member 40 further includes a protrusion 42A protruding in the Z direction from the compressed portion 41A between the body 23 and the first flange 24A, and a protrusion 42B protruding in the Z direction from the compressed portion 41B between the body 23 and the second flange 24B. The protrusions 42A and 42B of the exemplary embodiment protrude farther in the Z direction than the flanges 24A and 24B, respectively, and also protrude farther in the Z direction than the non-compressed portion 43. More specifically, the protrusion 42A protrudes farther in the Z direction than an end of the first flange 24A bent toward the second surface 22, and also protrudes farther in the Z direction than a surface facing the Z direction of the non-compressed portion 43. The protrusion 42B protrudes farther in the Z direction than an end of the second flange 24B bent toward the second surface 22, and also protrudes farther in the Z direction than the surface facing the Z direction of the non-compressed portion 43.

Note that, in the exemplary embodiment, the protrusions 42A and 42B each correspond to a deformed portion of the porous member 40 bent in a bending step of the base 20 to be described later. The protrusions 42A and 42B are alternately disposed in the X direction as with the flanges 24A and 24B.

The porous member 40 is provided with recesses 45 each having a shape that is surrounded by the protrusions 42A and 42B and the non-compressed portion 43 and is open in the Z direction. In FIG. 2, for example, for some of multiple recesses 45, respective areas of the recesses 45 are indicated by two-dot chain lines.

Note that, in the exemplary embodiment, since the protrusions 42A and 42B are alternately disposed in the X direction, the recesses 45 each define a space closed on both sides along directions inclined with respect to the Y direction in an XY plane. In other words, the recesses 45 are open in each of the X direction and the Y direction. Further, the recess 45 is provided between the protrusion 42A and each of the protrusions 42B disposed on both sides in the X direction with respect to that protrusion 42A. Likewise, the recess 45 is provided between the protrusion 42B and each of the protrusions 42A disposed on both sides in the X direction with respect to that protrusion 42B.

### Method of Manufacturing Surface Fastener 1

A method of manufacturing the surface fastener 1 according to the exemplary embodiment will be described.

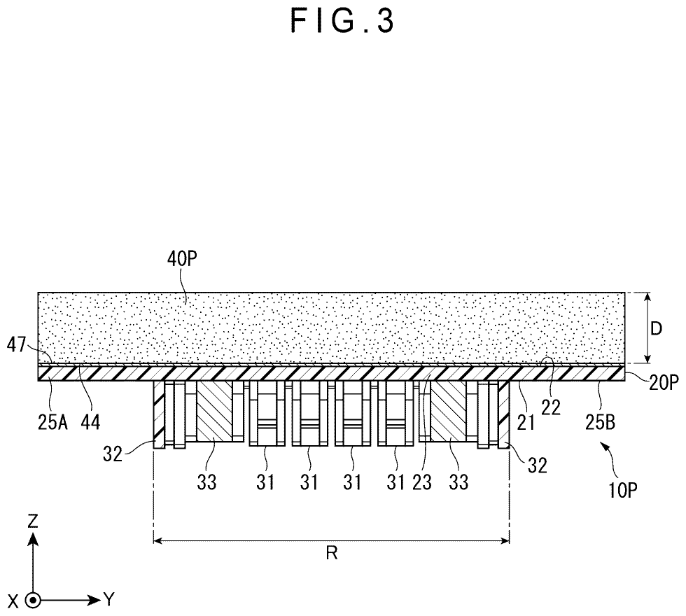

First, a fastener body 10P corresponding to the fastener body 10 before the flanges 24A and 24B are formed is prepared (see FIG. 3). Note that the fastener body 10P is provided with components including: a base 20P with a band shape having the first surface 21 and the second surface 22 that are in the front-back relationship; and the multiple engagement elements 31 provided in the element region R of the first surface 21 of the base 20P.

Next, as illustrated in FIG. 3, a porous member 40P having a flat plate shape is adhered to the second surface 22 of the base 20P (an adhesion step). Note that the porous member 40P corresponds to the porous member 40 prior to formation of the compressed portions 41A and 41B and the like, and has an adhesion surface 44 with a planar shape adhered to the second surface 22 of the base 20P. The porous member 40P is disposed to entirely cover the second surface 22 of the base 20P, while having a predetermined thickness D in the Z direction. The thickness D of the porous member 40P corresponds to a thickness of the non-compressed portion 43 described above, and is preferably greater than or equal to half of an extending length Lf of each of the flanges 24A and 24B (see, for example, FIGS. 1 and 4) and less than or equal to the extending length Lf.

Subsequently, end edge portions 25A and 25B, which are regions outside the element region R of the base 20P in the Y direction, are each cut into a predetermined shape (a cutting step). Accordingly, respective shapes corresponding to the multiple flanges 24A and 24B are formed on the end edge portions 25A and 25B of the base 20P, respectively. Further, in the cutting step, the porous member 40P is cut together with the base 20P. Thus, the respective shapes corresponding to the multiple flanges 24A and 24B are formed on the porous member 40P (see FIG. 4).

Incidentally, a specific method to be employed in the cutting step is optional and, for example, it is possible to use a rotary cutter. In the case of using the rotary cutter, a pair of rotary cutters perform cutting while sandwiching the porous member 40P and the base 20P in the Z direction, during conveyance in which the porous member 40P and the base 20P are conveyed in a conveyance direction along the X direction. When the cutting is performed, the porous member 40P is compressed by receiving, from the rotary cutters, a load having a component in a direction opposite to the conveyance direction. Therefore, a cut surface of the porous member 40P may be inclined with respect to the Z direction.

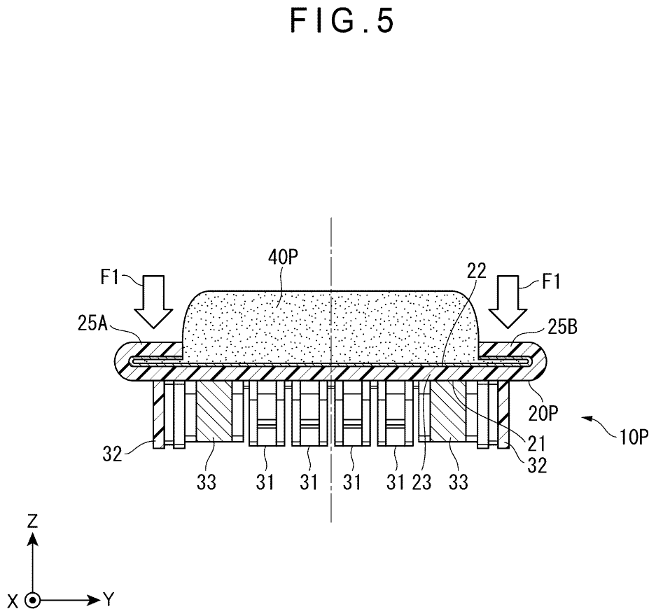

Next, the end edge portions 25A and 25B of the base 20P are bent together with the porous member 40P toward the second surface 22 of the base 20P with respect to the body 23 (the bending step). At this time, as illustrated in FIG. 5, it is preferable to apply an external force F1 to the end edge portions 25A and 25B until a bending angle of each of the end edge portions 25A and 25B with respect to the body 23 becomes less than or equal to 90 degrees, preferably until the bending angle becomes 0 degrees. At this time, bent portions of the base 20P (that is, the one end portion 231A and the other end portion 231B of the body 23) are each bent until plastic deformation occurs. Note that FIG. 5 is a cross-sectional diagram taken along the line A-A and viewed in a direction indicated by arrows in FIG. 2. In a state where the bending angle of each of the end edge portions 25A and 25B with respect to the body 23 becomes 0 degrees, the end edge portions 25A and 25B are overlapped in the Z direction with the body 23, with the porous member 40P in a compressed state interposed between the body 23 and each of the end edge portions 25A and 25B.

Thereafter, the external force F1 is released from the end edge portions 25A and 25B of the base 20P (a spring back step). At this time, the end edge portions 25A and 25B of the base 20P rise with respect to the body 23 while being restored to their original states to some extent by an elastic force of each of the end edge portions 25A and 25B and/or a repulsive force of the porous member 40.

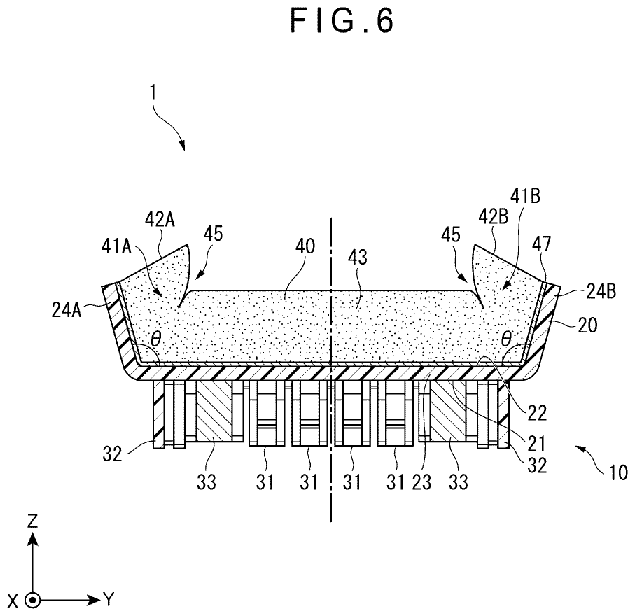

Here, the bending angle θ of each of the end edge portions 25A and 25B (i.e., the flanges 24A and 24B) in a state of rising with respect to the body 23 is preferably 90 degrees±10 degrees, as illustrated in FIG. 1. The bending angle θ of each of the flanges 24A and 24B is preferably less than or equal to 90 degrees, but may be greater than 90 degrees as illustrated in FIG. 6.

Note that the compressed portions 41A and 41B and the protrusions 42A and 42B of the porous member 40 are formed together with the rising of the end edge portions 25A and 25B of the base 20P. More specifically, since the one end portion 231A and the other end portion 231B of the body 23 are plastically deformed, the rising of the end edge portions 25A and 25B of the base 20P can be maintained though the end edge portions 25A and 25B receive the repulsive force of the compressed porous member 40. The compressed portions 41A and 41B and the protrusions 42A and 42B of the porous member 40 are thereby formed.

After the preferable bending angle θ of each of the flanges 24A and 24B is achieved by the spring back step, a curing step of curing the compressed portions 41A and 41B by welding or by an adhesive may be performed.

The surface fastener 1 is thus manufactured. Multiple surface fasteners 1 manufactured in this manner may be packed and shipped in a stacked state.

Note that, though a case where one surface fastener 1 is manufactured has been described above, multiple surface fasteners 1 may be manufactured concurrently. For example, a composite material having a large width that corresponds to a state where multiple fastener bodies 10P are arranged in the Y direction may be prepared (a preparation step), and the porous member 40P having a large width may be adhered to the composite material (an adhesion step). Thereafter, when the composite material is cut together with the porous member 40P having the large width, the end edge portions 25A and 25B of the multiple fastener bodies 10P may each be cut into a predetermined shape while the composite material is cut into the multiple fastener bodies 10P (a cutting step).

Further, a step of cutting a part of the surface fastener 1 together with the porous member 40 and the base 20 may be performed, before or after the bending step. For example, in order to improve flexibility of the surface fastener 1, the surface fastener 1 may be partially cut from both sides in the Y direction to form a narrow portion.

### Installation of Surface Fastener 1

A method of installing the surface fastener 1 in the cushion body will be briefly described.

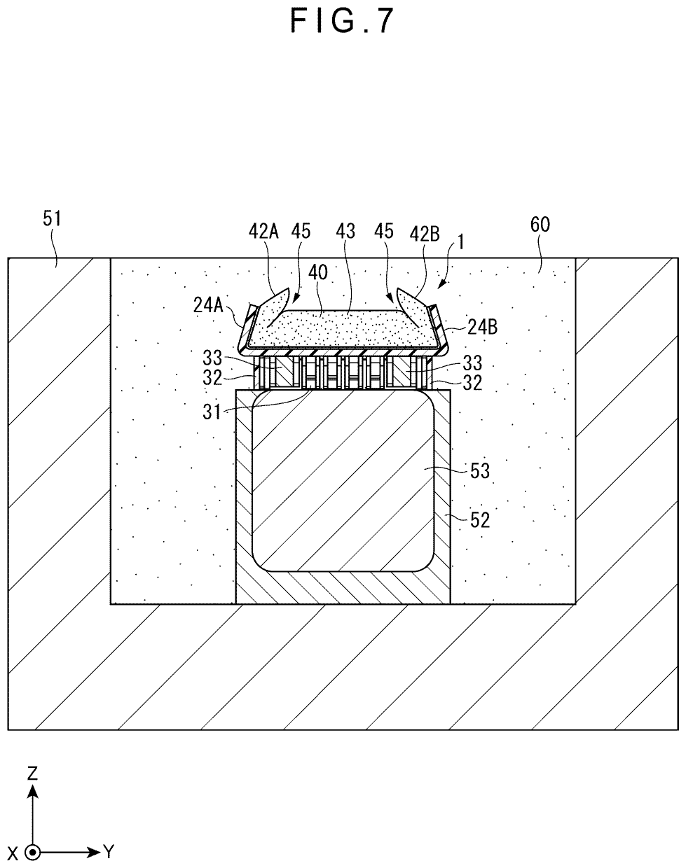

First, as illustrated in FIG. 7, the surface fastener 1 is placed on a base portion 52 provided in a molding tool 51 of the cushion body. Note that a magnet 53 such as a neodymium magnet is disposed inside the base portion 52. The magnet 53 magnetically attracts the magnetic elements 33 of the surface fastener 1, and retains a position of the surface fastener 1. At this time, the bending angle θ of each of the flanges 24A and 24B being less than or equal to 90 degrees makes it easier for an operator to check the base portion 52 and improves operability.

Subsequently, a foam resin that is a raw material of the cushion body is injected into the molding tool 51. When filling the periphery of the surface fastener 1 with the foam resin, the foam resin is received by the recesses 45 provided between the protrusions 42A and 42B and the non-compressed portion 43 of the porous member 40, and while the recesses 45 are filled with the foam resin, the foam resin permeates into the porous member 40. Note that the protrusions 42A and 42B are alternately disposed in the X direction, and therefore a flow of the foam resin hardly stops and the foam resin easily spreads over an entire surface of the surface fastener 1.

At this time, the walls 32 of the surface fastener 1 prevent the foam resin from entering the element region R.

The foam resin injected into the molding tool 51 foams and solidifies to form a cushion body 60. The surface fastener 1 is thereby integrated with the surface of the cushion body 60. In the surface fastener 1 integrated with the surface of the cushion body 60, the flanges 24A and 24B and the porous member 40 are disposed inside the cushion body 60.

### Effects of Exemplary Embodiment

As described above, the surface fastener 1 according to the exemplary embodiment includes: the base 20 having the first surface 21 and the second surface 22 that are in the front-back relationship; the multiple engagement elements 31 provided in the element region R of the first surface 21 of the base 20; and the porous member 40 provided on the second surface 22 of the base 20 and having flexibility. The base 20 includes: the body 23 including the element region R; and the flanges 24A and 24B each extending from the body 23 and each having the shape that is bent toward the second surface 22 with respect to the body 23. The porous member 40 includes the compressed portions 41A and 41B each compressed between the body 23 and corresponding one of the flanges 24A and 24B.

In the surface fastener 1 of the exemplary embodiment as described above, it is possible to maintain the bent shapes of the flanges 24A and 24B by the compressed portions 41A and 41B of the porous member 40.

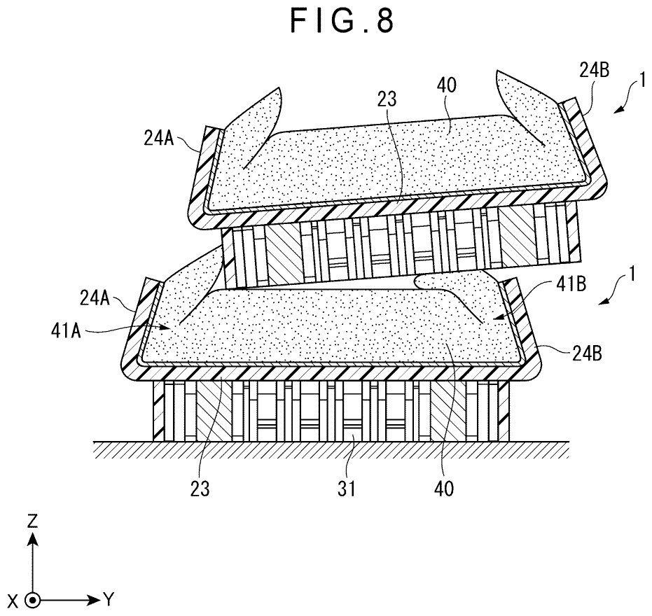

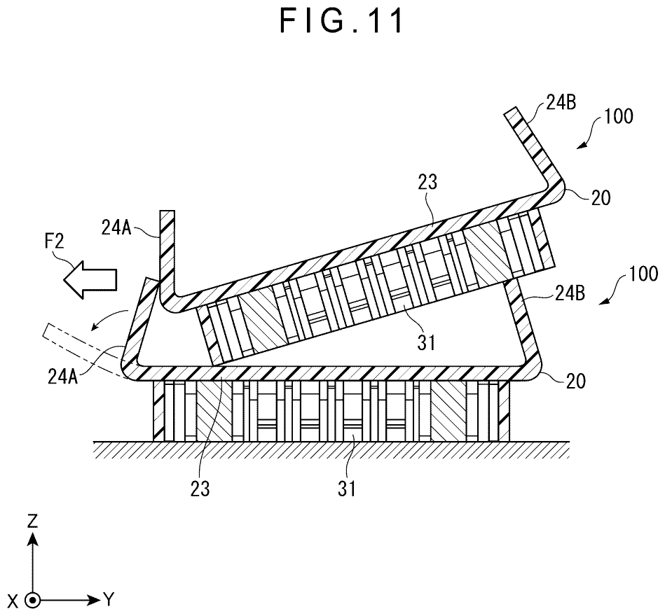

Here, in order to specifically describe effects of the exemplary embodiment, a state where the surface fasteners 1 of the exemplary embodiment are stacked on each other (see FIG. 8) and a state where surface fasteners 100 of a comparative example are stacked on each other (FIG. 11) are exemplified. Note that the surface fasteners 100 of the comparative example each have a configuration in which the porous member 40 is removed from the surface fastener 1 of the exemplary embodiment. In the comparative example, the same codes as those of the exemplary embodiment are used for components similar to those of the exemplary embodiment.

As illustrated in FIG. 11, in the comparative example, it occurs at times that the surface fastener 100 on an upper side enters a space surrounded by the body 23 and the flanges 24A and 24B of the surface fastener 100 on a lower side, and applies a load F2 that is an outward load in the Y direction to the flanges 24A and 24B. The flanges 24A and 24B to which the load F2 is applied occasionally pivot outward in the Y direction and are bent back. Note that FIG. 11 illustrates an example in which the load F2 outward in the Y direction is applied to the first flange 24A and the first flange 24A is bent back.

In contrast, as illustrated in FIG. 8, in the exemplary embodiment, it is possible for the compressed portions 41A and 41B of the porous member 40 of the surface fastener 1 on a lower side to support the surface fastener 1 on an upper side. Accordingly, the surface fastener 1 on the upper side hardly enters a space surrounded by the body 23 and the flanges 24A and 24B of the surface fastener 1 on the lower side, and a load in a direction of widening the bending (outward in the Y direction) is hardly applied to the flanges 24A and 24B of the surface fastener 1 on the lower side. As a result, it is possible to maintain the bent shape of each of the flanges 24A and 24B of the surface fastener 1 on the lower side.

In the exemplary embodiment, it is possible to maintain the bent shape of each of the flanges 24A and 24B also when the bending angle θ of each of the flanges 24A and 24B is greater than 90 degrees (for example, see FIG. 6).

For example, in the comparative example, when the bending angle θ of each of the flanges 24A and 24B is greater than 90 degrees, a downward load may be applied to the flanges 24A and 24B of the surface fastener 1 on the lower side from the surface fastener 1 on the upper side, and the downward load may be converted into a load in the direction of widening the bending of the flanges 24A and 24B (outward in the Y direction).

In contrast, in the exemplary embodiment, it is possible that the compressed portions 41A and 41B of the porous member 40 of the surface fastener 1 on the lower side receive the load from the surface fastener 1 on the upper side, and restrain the downward load from being applied to the flanges 24A and 24B. Accordingly, the bent shape of each of the flanges 24A and 24B can be maintained.

Further, since a raw material of the cushion material is permeable into the porous member 40, each of the flanges 24A and 24B is disposed in a state of being placed deeply in the cushion body 60, though the porous member 40 exists between the body 23 and each of the flanges 24A and 24B. This makes it possible to achieve installation of the surface fastener 1 in the cushion body 60 without impairing the adhesion property of the surface fastener that is an original object of the flanges 24A and 24B. In addition, the permeation of the raw material of the cushion body 60 into the porous member 40 increases a contact area between the porous member 40 and the cushion body 60, which makes it possible to improve the adhesion property of the surface fastener 1.

Accordingly, the exemplary embodiment provides the surface fastener 1 in which the adhesion property to the cushion body 60 can be improved while the bent shape of each of the flanges 24A and 24B is maintained.

In the exemplary embodiment, the porous member 40 is provided on the second surface 22 of the base 20, to cover the body 23 and the flanges 24A and 24B. With such a configuration, the porous member 40 has a shape that is bent between the body 23 and each of the flanges 24A and 24B, and it is possible to suitably provide the compressed portions 41A and 41B.

In the exemplary embodiment, where the direction from the first surface 21 toward the second surface 22 in the body 23 is defined as the predetermined direction (the Z direction), the porous member 40 further includes the protrusions 42A and 42B each protruding farther in the predetermined direction than corresponding one of the flanges 24A and 24B.

With such a configuration, it is possible to dispose the protrusions 42A and 42B deeply inside the cushion body 60 when the cushion body 60 is formed, and to further improve the adhesion property of the surface fastener 1.

In the exemplary embodiment, the porous member 40 further includes the non-compressed portion 43 disposed on the body 23, and the recesses 45 are provided between the non-compressed portion 43 and the protrusions 42A and 42B.

With such a configuration, when the cushion body 60 is formed, the raw material of the cushion body 60 flows into the recesses 45 and solidifies, which makes it possible for the porous member 40 to hold a part of the cushion body 60. Accordingly, the adhesion property of the surface fastener 1 can be further improved.

In the exemplary embodiment, the porous member 40 is made of foam. With this arrangement, the porous member 40 can be easily compressed, and the compressed portions 41A and 41B of the porous member 40 can be easily formed by performing a bending process on the base 20P.

In the exemplary embodiment, the compressed portions 41A and 41B are each cured by welding or by an adhesive. With this arrangement, it is possible to suppress an elastic force of each of the compressed portions 41A and 41B, and to more suitably maintain the bent shape of each of the flanges 24A and 24B.

In the exemplary embodiment, the base 20 includes the first flange 24A extending from one side in a width direction of the body 23 and the second flange 24B extending from another side in the width direction of the body 23, and the porous member 40 includes the compressed portion 41A between the body 23 and the first flange 24A and the compressed portion 41B between the body 23 and the second flange 24B.

With such a configuration, since the compressed portions 41A and 41B are provided on both sides in the width direction of the body 23, it is possible that the compressed portions 41A and 41B share and support a load applied to the surface fastener 1. Therefore, the respective bent shapes of the first flange 24A and the second flange 24B can be suitably maintained.

The method of manufacturing the surface fastener 1 according to the exemplary embodiment includes, as described above: the preparation step of preparing the fastener body 10P including the base 20P and the multiple engagement elements 31; the adhesion step of adhering the porous member 40P with flexibility to the second surface 22 of the base 20P; and the bending step of bending the end edge portions 25A and 25B of the base 20P together with the porous member 40P toward the second surface 22 of the base 20P with respect to the body 23 of the base 20P.

With such a method, it is possible to suitably manufacture the surface fastener 1 described above.

In the exemplary embodiment, in the bending step, the external force F1 is applied to the end edge portions 25A and 25B until the bending angle of each of the end edge portions 25A and 25B with respect to the body 23 becomes less than or equal to 90 degrees. With such a method, it is possible to suitably maintain the bent shape of each of the end edge portions 25A and 25B (i.e., the flanges 24A and 24B) while raising the end edge portions 25A and 25B from the body 23, by utilizing restoring of the end edge portions 25A and 25B to their original states to some extent with use of the elastic force of each of the end edge portions 25A and 25B and/or the repulsive force of the porous member 40P.

In the exemplary embodiment, the thickness D in the Z direction of each of the compressed portions 41A and 41B prior to the bending step is preferably greater than or equal to half of the extending length Lf of each of the flanges 24A and 24B. With this arrangement, it is possible to form the compressed portions 41A and 41B that are each so increased in density as to have a suitable strength.

Further, in the exemplary embodiment, the thickness D in the Z direction of each of the compressed portions 41A and 41B prior to the bending step is preferably less than or equal to the extending length Lf of each of the flanges 24A and 24B. With this arrangement, it is possible to form the protrusions 42A and 42B by the bending of the porous member 40 in the bending step.

### Modifications

In the exemplary embodiment described above, modifications for maintaining the bent shape of each of the flanges 24A and 24B may be performed.

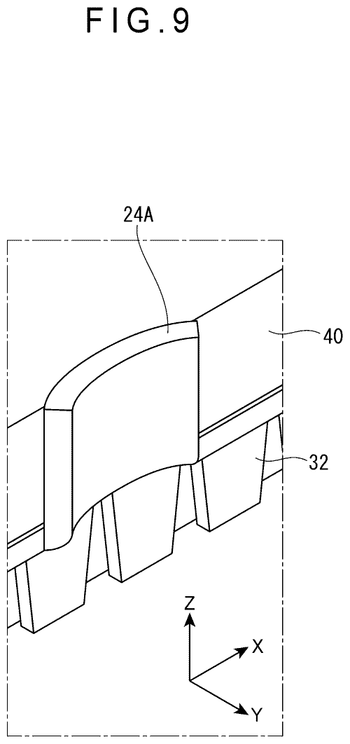

For example, as illustrated in FIG. 9, a bending line of the first flange 24A (or the second flange 24B) may be curved inward in the Y direction. In this case, a groove along the bending line of the flange 24A or 24B may be provided on the second surface 22 of the base 20.

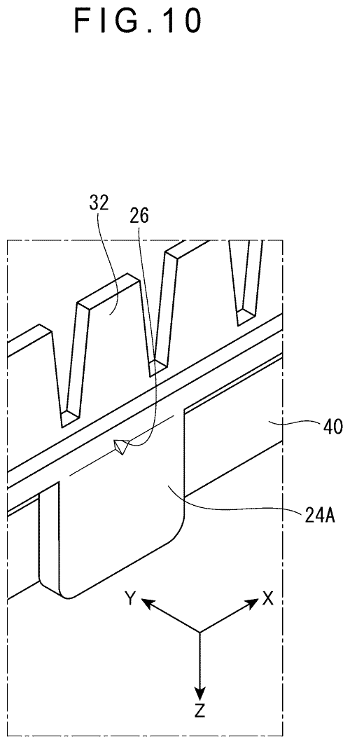

Further, as illustrated in FIG. 10, a V-shape groove 26 along the Z direction may be provided on a corner of the bent shape of the first flange 24A (or the second flange 24B). It is possible to form such a V-shape groove 26 by pressing a tapered tool against the corner, for example.

In the exemplary embodiment described above, shapes, bending positions, etc., of the flanges 24A and 24B are changeable.

For example, in the exemplary embodiment described above, the shapes corresponding to the multiple flanges 24A and 24B are formed by cutting the end edge portions 25A and 25B of the base 20P into predetermined shapes; however, such a cutting step needs not be performed, or a cutting step of cutting the end edge portions 25A and 25B into any other shape may be performed. That is, the flanges 24A and 24B may at least be the end edge portions 25A and 25B of the base 20P that are bent with respect to the body 23.

Further, in the exemplary embodiment described above, the base 20 includes both the first flange 24A and the second flange 24B, but may include either one of the first flange 24A or the second flange 24B. For example, in the bending process of the exemplary embodiment described above, one of the end edge portions 25A and 25B of the base 20P may be bent and the other needs not be bent. Further, one of the end edge portions 25A and 25B of the base 20P that is to be bent may be determined depending on a shape of the cushion body 60 to be attached.

In the exemplary embodiment described above, a shape or a dimension of the porous member 40 is changeable.

For example, in the exemplary embodiment described above, the porous member 40 prior to being bent (i.e., the porous member 40P) has the flat plate shape, but may have any other shape. Here, the thickness D of the porous member 40P prior to being compressed may at least be a thickness sufficient to form each of the compressed portions 41A and 41B between the body 23 and corresponding one of the flanges 24A and 24B.

Further, in the exemplary embodiment described above, the porous member 40 includes the protrusions 42A and 42B, but needs not include the protrusion 42A and 42B.

Further, in the exemplary embodiment described above, the porous member 40 needs not cover the entire surface of the second surface 22 of the base 20, and a partial region of the second surface 22 of the base 20 may be exposed without being covered with the porous member 40.

1. A surface fastener to be integrated with a surface of a cushion body, the surface fastener comprising:
a base made of a resin, the base having a first surface and a second surface that are in a front-back relationship;
a plurality of engagement elements provided in an element region of the first surface of the base; and
a porous member provided on the second surface of the base and having flexibility, wherein
the base comprises
a body including the element region, and
a flange extending from the body and having a shape that is bent toward the second surface with respect to the body, and
the porous member includes a compressed portion compressed between the body and the flange.

2. The surface fastener according to claim 1, wherein the porous member is provided on the second surface of the base, to cover the body and the flange.

3. The surface fastener according to claim 1, wherein, when a direction from the first surface toward the second surface in the body is defined as a predetermined direction, the porous member further comprises a protrusion protruding farther in the predetermined direction than the flange.

4. The surface fastener according to claim 3, wherein
the porous member further comprises a non-compressed portion disposed at the body, and
a recess is provided between the protrusion and the non-compressed portion.

5. The surface fastener according to claim 1, wherein the porous member is made of foam.

6. The surface fastener according to claim 1, wherein the compressed portion is cured by welding or by an adhesive.

7. The surface fastener according to claim 1, wherein
the base comprises, as the flange, a first flange and a second flange, the first flange extending from one side in a width direction of the body, the second flange extending from another side in the width direction of the body, and
the porous member comprises the compressed portion between the body and the first flange and the compressed portion between the body and the second flange.

8. A method of manufacturing a surface fastener to be integrated with a surface of a cushion body, the method comprising:
preparing a fastener body, the fastener body comprising a base made of resin and a plurality of engagement elements, the base having a first surface and a second surface that are in a front-back relationship, the plurality of engagement elements being provided in an element region of the first surface of the base;
adhering a porous member to the second surface of the base, the porous member having flexibility; and
bending an end edge portion of the base together with the porous member toward the second surface of the base, with respect to a body of the base, the body including the element region.

9. The method of manufacturing the surface fastener according to claim 8, wherein in the bending, an external force is applied to the end edge portion until a bending angle of the end edge portion with respect to the body becomes less than or equal to 90 degrees.
